(19) United States
(12) Patent Application Publication
(10) Pub. No.: US 2008/0064807 A1
(43) Pub. Date: Mar. 13, 2008

(54) Coating of Household Articles by Means of Thermoplastic Elastomers

(75) Inventors: Jurgen Weidinger, Polling (DE); Adelheid Durnberger, Mattighofen (AT); Johann Kammerer, Julbach (DE); Roland W. Verbeek, Niederlande (NL)

Correspondence Address: BROOKS KUSHMAN P.C., 1000 TOWN CENTER, TWENTY-SECOND FLOOR, SOUTHFIELD, MI, 48075, US

(73) Assignees: WACKER CHEMIE AG, Munich (DE); THE MECCANO COMPANY B.V., NB Laren (NL)

(21) Appl. No.: 11/575,837

(22) PCT Filed: Sep. 22, 2005
(86) PCT No.: PCT/EP05/10276

§ 371 Date: Mar. 22, 2007

(30) Foreign Application Priority Data
Sep. 30, 2004 (DE) 10 2004 047 705.1

(51) Int. Cl. C08K 3/04; B05D 1/02; B05D 1/18; C08L 83/04; B05D 3/00; B29C 45/00

(52) U.S. Cl. 524/496; 156/60; 264/328.1; 427/387; 427/427.4; 427/430.1; 525/478

(57) ABSTRACT

Considerable noise reduction in the handling of kitchenware is achieved by at least partially coating the kitchenware with an organopolysiloxane elastomer. Breakage is also reduced thereby.

The invention relates to the use of elastomers and of thermoplastic elastomers for the coating, forming, and overmolding of household articles, such as plates, cups, glasses, dishes, pots, pans, cutlery, saucers, bowls, vases, and kitchenware for baking, or for frying, composed of metal, ceramics, such as stoneware, porcelain, or clay, glass, or plastic in any desired shape, size, and design, for which the general term “kitchenware” is used below, so that these produce less noise when handled, and so as to increase safety during use, and also to production of the same, extending to production and use of entire kitchenware components composed of elastomer material or of thermoplastic elastomer material.

When kitchenware composed of stoneware, porcelain, glass, metal, or else of plastic and of other materials is handled, noise is produced, as a function of quantity, material, and geometry. The extent of this noise can be such as to generate legal requirements such as those prescribed for large-scale kitchens, stipulating that hearing protection be worn. However, practical reasons and lack of technology often mean that these requirements are circumvented. Especially in the case of hard materials, such as porcelain, both the level of noise and its frequencies are within the range that can damage the human ear. Furthermore, in the case of almost all of the materials used there is a relatively high level of risk of deformation, breakage, and injury during normal handling (household sector) and also especially during intensive handling (large-scale kitchens, catering), especially as a result of splintering and particularly in the case of ceramic materials and glass. Methods of countering these disadvantages have hitherto been non-existent or very inadequate; for example, the international patent application WO2003 024286 A1 describes a plate composed of plastics material but with a very complicated double-wall structure for the purposes of temperature-control of baby food, and not for the purposes of noise reduction and improving breakage safety. The international patent application WO2002 26087 A2 mentions combinations of hard and soft plastics for kitchenware for babies, with no reference to the abovementioned problems of noise reduction and safety. Patent application EP 1 273 626 A1 described merely a resin for internal coating of pots, the main considerations being hygiene. Plastics foils or plastics coating on glass have long been used to avoid splintering in the case of specialized glass-products, for example in vacuum apparatus with the Schott Duran® tradename. However, these do not prevent breakage and do not reduce noise level, and are not suitable for foods. Kitchenware for babies, especially, is often provided with antislip modification, preferably composed of rubber. A few household items, such as cheese graters, are equipped to some extent with antislip modification. However, the aspect of noise reduction and of long-term resistance is missing here, and is achievable only via suitable bonding technology and materials selection.

It is an object of the invention to mitigate or as far as possible entirely eliminate the disadvantages mentioned of the prior art, and to provide kitchenware which has a low noise level and is breakage-resistant.

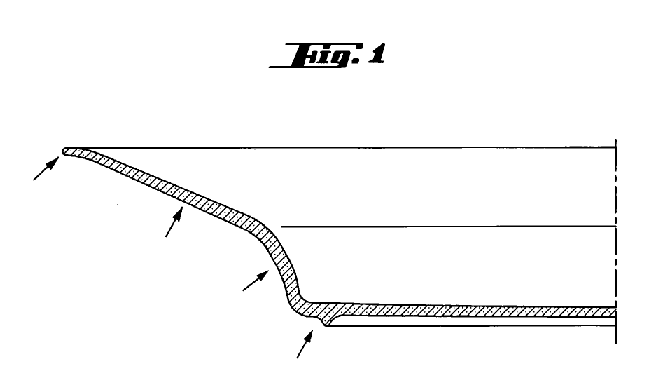

Surprisingly, it has been shown that kitchenware with a coating at least at the sites (FIG. 1) critical for noise generation and breakage, or kitchenware components entirely produced from elastomers, preferably from silicones, considerably reduce noise generation.

According to the invention, silicones have particularly good suitability, because they have a high level of damping action, as previously described in “Kunststoffberater” 3/2001. Table 1 in particular provides evidence of the inventive property of the silicones in reducing noise generation. Table 1 shows subjective evaluation, recording the criteria of frequency, reverberation, and loudness of the noise perceived when a hammer is used to impact an inventively coated porcelain test specimen.

TABLE 1
Subjective evaluation of noise on the impact of a hammer on an
inventively coated porcelain test specimen, (+++) meaning
very low, (++) low, (+) moderate, (−) high, (−−) very high and (−−−)
extremely high, for uncoated porcelain.

Layer thickness [mm]

| Coating composition | 0.5 | 1 | 2 | 4 |
|---|---|---|---|---|
| Shore A 25 silicone | −− | ++ | ++ | +++ |
| Shore A 25 silicone | −− | − | ++ | +++ |
| Shore A 30 silicone | − | −− | − | ++ |
| Shore A 40 silicone | − | ++ | ++ | +++ |
| Shore A 35 silicone | −− | − | − | ++ |
| Swedac “damping compound” | −− | −− | −− | −− |
| (organic rubber) | | | | |
| Shore A 40 polyurethane | −− | −− | − | + |

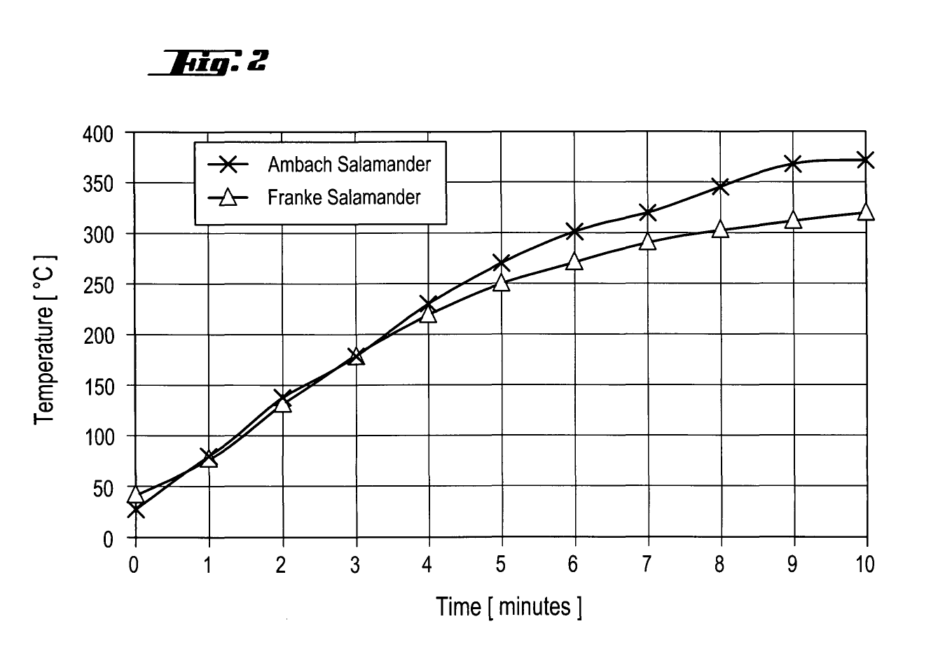

Materials which may be used here are in principle elastomers in the widest sense, i.e. thermoplastic elastomers (TPEs) and traditional elastomers, such as latex or rubber; among these preference is given to those which comply with kitchenware use requirements, i.e. materials which are resistant to heat, low temperature, and cleaning compositions, and which are suitable for foods, silicones being particularly preferred. FIG. 2 illustrates the temperature curve for an empty kitchenware component in a (“Salamander”) apparatus typically used for storing hot food in large-scale kitchens. Even after less than 4 minutes, two commercially available Salamanders (Ambach Salamander, Franke Salamander) reach temperatures above 200° C. Silicone is the only suitable elastomer material that withstands this temperature.

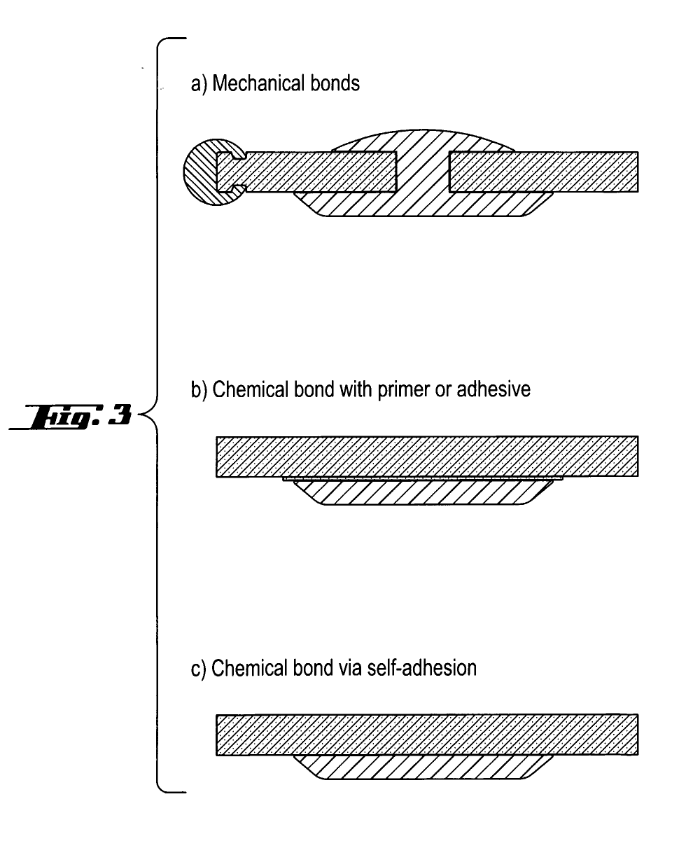

The elastomer material is preferably applied after production of the kitchenware component, and specifically via coating, for example via spray-application, dipping, doctor-application, via overmolding, for example by means of injection molding or compression molding), via adhesive bonding, for example using an elastomer component previously produced via any desired shaping process, or via bonding, for example by means of a separate substrate which is intended for the elastomer component and which can be applied to the kitchenware. The bonding of kitchenware component to the elastomer material is preferably chemical bonding, i.e. chemical adhesion. However, it may also take place via mechanical grip, for example via undercuts or perforation film as shown by way of example in FIG. 3a to c. To achieve a chemical bond, adhesive and primer in the widest sense may be used, but preferably, for cost-effective production, elastomer materials which themselves adhere to the kitchenware substrate with or without the help of a primer. Silicone is again preferred here, because the morphology of the partly inorganic silicone (Si—O polymer backbone) is related to most kitchenware materials, such as ceramics, glass, and also oxidizable metals, and favors good adhesion. Depending on the system used, the method of hardening of the elastomer component may involve cooling or heating, or, respectively, curing.

Examples of available forms of the preferred material, silicone, are room-temperature-(RTV) and high-temperature-crosslinking (HTV) systems with various vulcanization characteristics, selected from the group consisting of condensation crosslinking and platinum-catalyzed addition crosslinking. Particular preference is given to high-temperature-vulcanizing solid and liquid silicones (HCRs and LSRs) which have self-adhesive properties, for example as described in the European patents EP 1 375 622 B1 and EP 1 266 948 B1, because these have excellent properties. These particularly preferred materials feature direct chemical bonding with the substrate material, the most cost-effective processing in automatic, direct single-stage application, excellent mechanical properties, high general resistance, high transparency, and also capability for coloring as desired, pleasant and relatively slip-free hand, suitability for foods (e.g. to BfR XV “Silicone” [silicones], and FDA CFR 21 §177.2600 “Rubber articles for repeated use”), and safety in use, for example by not acting, or melting, in such a way as to spread fire, and also by forming no toxic combustion products in the event of a fire.

The inventively coated kitchenware has antislip properties, and is suitable for foods, and is durable.

The particularly preferred materials may comprise:
(A) compounds which have radicals having aliphatic carbon-carbon multiple bonds,
(B) organopolysiloxanes having S-bonded hydrogen atoms, or, instead of (A) and (B),
(C) organopolysiloxanes which have SiC-bonded radicals having aliphatic carbon-carbon multiple bonds and having Si-bonded hydrogen atoms, and
(D) organic peroxides of the general formula R′—O—O—R″, or catalysts which comprise platinum and/or comprise rhodium and which have the general formula MLₓ, where M is rhodium or platinum, and L can be any desired identical or different ligands, these preferably being selected from the group consisting of the compounds of the general formulae (III)-(VI):

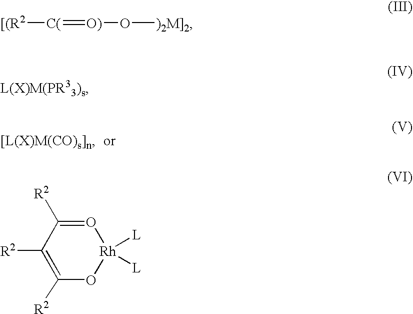

or the analog of (VI) having platinum as central atom,

where
R′ may be identical or different, and is a hydrogen atom or monovalent, if appropriate substituted, hydrocarbon radicals having from 1 to 24 carbon atoms,
R″ may be identical or different, and is a hydrogen atom or monovalent, if appropriate substituted, hydrocarbon radicals having from 1 to 24 carbon atoms,
R² may be identical or different, and is a hydrogen atom or monovalent, if appropriate substituted, hydrocarbon radicals having from 1 to 24 carbon atoms,
R³ may be identical or different, and is hydrogen, —OR⁴, or monovalent, if appropriate substituted, hydrocarbon radicals having from 1 to 24 carbon atoms,
R⁴ may be identical or different and is a hydrogen atom, or a monovalent, if appropriate substituted, hydrocarbon radical having from 1 to 20 carbon atoms,
X may be identical or different, and is halogen or hydrogen,
L may be identical or different, and is CO, acetylacetonate, 0.5 cycooctadiene, 0.5 norbornadiene, or P(R³)₃, and
M is rhodium or platinum,
s is 2 or 3, and
n is from 1 to 5.

If the radicals are substituted radicals, preferred substituents are halogen atoms, such as F, Cl, Br, and I, cyano radicals, heteroatoms, such as O, S, N, and P, and also groups—preferably OR⁴, where R⁴ is as defined above.

The preferred compositions may be single-component organopolysiloxane compositions or else multicomponent organopolysiloxane compositions. In the latter case, the various components of the inventive compositions may comprise any of the constituents in any desired combination, generally with the proviso that a component intended for metal-atom-catalyzed addition crosslinking does not simultaneously comprise siloxanes with an aliphatic multiple bond, siloxanes having Si-bonded hydrogen, and catalyst, i.e. in essence does not simultaneously comprise constituents (A), (B), and (D) or, respectively, (C) and (D). It is particularly preferable here that one component comprises constituents (A), (B), and/or only (C), and that the other component(s) comprise(s) (A) and (D).

The compounds (A) and (B) and, respectively, (C) used in the particularly preferred compositions are selected in a known manner so as to permit crosslinking. For example, compound (A) has at least two aliphatically unsaturated radicals and siloxane (B) has at least three Si-bonded hydrogen atoms, or compound (A) has at least three aliphatically unsaturated radicals and siloxane (B) has at least two Si-bonded hydrogen atoms, or else, instead of compound (A) and (B), siloxane (C) is used and has aliphatically unsaturated radicals and Si-bonded hydrogen atoms in the abovementioned ratios.

The silicone compositions preferably comprise, as constituent (A), an aliphatically unsaturated organosilicon compound, and it is possible here to use any of the aliphatically unsaturated organosilicon compounds used hitherto in addition-crosslinking compositions, and these comprise, by way of example, silicone block copolymers containing at least one segment selected from the group consisting of amide segments, imide segments, ester/amide segments, polystyrene segments, silarylene segments, and carborane segments, or comprise silicone graft copolymers having ether groups.

The organosilicone compounds (A) used which have SiC-bonded radicals having aliphatic carbon-carbon multiple bonds are preferably linear or branched organopolysiloxanes composed of units of the general formula (I)
RₐR¹_{b}SiO_{(4-a-b)/2} (I)

where
R may be identical or different, and is an organic radical free from aliphatic carbon-carbon multiple bonds,
R¹ may be identical or different, and is a monovalent, if appropriate substituted, SiC-bonded hydrocarbon radical having an aliphatic carbon-carbon multiple bond,
a is 0, 1, 2, or 3, and
b is 0, 1, or 2,

with the proviso that the sum a+b is less than or equal to 3, and the average number of R¹ radicals present per molecule is at least 2.

Examples of radicals R are alkyl radicals, such as the methyl, ethyl, n-propyl, isopropyl, n-butyl, isobutyl, tert-butyl, n-pentyl, isopentyl, neopentyl, tert-pentyl radical, hexyl radicals, such as the n-hexyl radical; heptyl radicals, such as the n-heptyl radical, octyl radicals, such as the n-octyl radical and isooctyl radicals, such as the 2,2,4-trimethylpentyl radical, nonyl radicals, such as the n-nonyl radical, decyl radicals, such as the n-decyl radical, dodecyl radicals, such as the n-dodecyl radical, and octadecyl radicals, such as the n-octadecyl radical, cycloalkyl radicals, such as cyclopentyl, cyclohexyl, cycloheptyl, and methylcyclohexyl radicals, aryl radicals, such as the phenyl, naphthyl, anthryl, and phenanthryl radical, alkaryl radicals, such as o-, m-, and p-tolyl radicals, xylyl radicals, and ethylphenyl radicals, and aralkyl radicals, such as the benzyl radical, and the α- and β-phenylethyl radical.

Examples of substituted radicals R are haloalkyl radicals, such as the 3,3,3-trifluoro-n-propyl radical, the 2,2,2,2′,2′,2′-hexafluoroisopropyl radical, and the heptafluoroisopropyl radical, and haloaryl radicals, such as the o-, m-, and p-chlorophenyl radical.

The radical R is preferably a monovalent, SiC-bonded, if appropriate substituted, hydrocarbon radical free from aliphatic carbon-carbon multiple bonds and having from 1 to 18 carbon atoms, particularly preferably a monovalent, SiC-bonded hydrocarbon radical free from aliphatic carbon-carbon multiple bonds and having from 1 to 6 carbon atoms, in particular the methyl or phenyl radical.

The radical R¹ may be any desired groups available for an addition reaction (hydrosilylation) with a SiH-functional compound.

If the radical R¹ is SiC-bonded, substituted hydrocarbon radicals, preferred substituents are halogen atoms, cyano radicals, and —OR⁴, where R⁴ is as defined above.

The radical R¹ is preferably alkenyl and alkynyl groups having from 2 to 16 carbon atoms, e.g. vinyl, allyl, methallyl, 1-propenyl, 5-hexenyl, ethynyl, butadienyl, hexadienyl, cyclopentenyl, cyclopentadienyl, cyclohexenyl, vinylcyclohexylethyl, divinylcyclohexyl-ethyl, norbornenyl, vinylphenyl, and styryl radicals, and radicals particularly preferably used here are vinyl, allyl, and hexenyl radicals.

The molar mass of the constituent (A) may vary within wide boundaries, for example from 10² to 10⁶ g/mol. Constituent (A) may, therefore, for example, be a relatively low-molecular-weight alkenyl-functional oligosiloxane, such as 1,2-divinyltetramethyl-disiloxane, but may also be a highly polymerized polydimethylsiloxane having Si-bonded vinyl groups positioned along the chain or terminally, e.g. having a molar mass of 10⁵ g/mol (number average determined by NMR). Nor is the structure of the molecules forming the constituent (A) defined. In particular, the structure of a higher-molecular-weight, i.e. oligomeric or polymeric, siloxane may be linear, cyclic, branched or even resin-like or network-like. Linear and cyclic polysiloxanes are preferably composed of units of the formula R₃SiO_{1/2}, R¹R₂SiO_{1/2}, R¹RSiO_{2/2} and R₂SiO_{2/2}, where R and R¹ are as defined above. Branched and network-like polysiloxanes additionally contain trifunctional and/or tetrafunctional units, where preference is given to those of the formulae RSiO_{3/2}, R¹SiO_{2/2} and SiO_{4/2}. It is, of course, also possible to use mixtures of different siloxanes meeting the criteria for the constituent (A).

The component (A) used particularly preferably comprises vinyl-functional, essentially linear, polydiorganosiloxanes with a viscosity of from 0.01 to 500,000 Pa·s, particularly preferably from 0.1 to 100,000 Pa·s, in each case at 25° C. For compositions of relatively high viscosity, the same preconditions apply, but with preferred viscosities of from 100 000 Pa·s to 8 000 000 Pa·s.

The organosilicon compound (B) used may be any hydrogen-functional organosilicon compounds among those hitherto used in addition-crosslinkable compositions.

The organopolysiloxanes (B) used which have Si-bonded hydrogen atoms are preferably linear, cyclic or branched organopolysiloxanes composed of units of the general formula (II)
R_{c}H_{d}SiO_{(4-c-d)/2} (II)

where
R may be identical or different and is as defined above,
c is 0, 1, 2 or 3, and
d is 0, 1 or 2,

with the proviso that the sum c+d is less than or equal to 3 and the average number of Si-bonded hydrogen atoms present per molecule is at least two.

The organopolysiloxane (B) used according to the invention preferably contains Si-bonded hydrogen in the range from 0.04 to 1.7% by weight, based on the total weight of the organopolysiloxane (B).

The molar-mass of the constituent (B) may likewise vary within wide boundaries, for example from 10² to 10⁶ g/mol. Constituent (B) may, therefore, for example, be a relatively low-molecular-weight SiH-functional oligosiloxane, such as tetramethyldisiloxane, but may also be a highly polymeric polydimethylsiloxane having SiH groups positioned along the chain or terminally, or a silicone resin having SiH groups. Nor is the structure of the molecules forming the constituent (B) defined. In particular, the structure of a higher-molecular-weight, i.e. oligomeric or polymeric, SiH-containing siloxane may be linear, cyclic, branched or else resin-like or network-like. Linear and cyclic polysiloxanes are preferably composed of units of the formula R₃SiO_{1/2}, HR₂SiO_{1/2}, HRSiO_{2/2} and R₂SiO_{2/2}, where R is as defined above. Branched and network-like polysiloxanes additionally contain trifunctional and/or tetrafunctional units, preferably those of the formulae RSiO_{3/2}, HSiO_{3/2} and SiO_{4/2}. It is, of course, also possible to use mixtures of different siloxanes meeting the criteria for the constituent (B). In particular, the molecules forming the constituent (B) may, in addition to the obligatory SiH groups, if desired at the same time also contain aliphatically unsaturated groups. Particular preference is given to the use of low-molecular-weight SiH-functional compounds, such as tetrakis(dimethylsiloxy)silane and tetramethylcyclo-tetrasiloxane, and also higher-molecular-weight SiH-containing siloxanes, such as poly(hydromethyl)siloxane and poly(dimethylhydromethyl)siloxane with a viscosity of from 10 to 10,000 mPa·s at 25° C., or analogous SiH-containing compounds in which some of the methyl groups have been replaced by 3,3,3-trifluoro-propyl or phenyl groups.

The amount of constituent (B) present in the novel crosslinkable silicone compositions is preferably such that the molar ratio of SiH groups to aliphatically unsaturated groups is from 0.1 to 20, particularly preferably from 0.8 to 4.0.

The components (A) and (B) used are commercially available products or can be prepared by common chemical processes.

Instead of components (A) and (B) the compositions may comprise organopolysiloxanes (C) which have aliphatic carbon-carbon multiple bonds and Si-bonded hydrogen atoms, but this is not preferred.

If siloxanes (C) ate used they are preferably composed of units of the general formula

R_{f}SiO_{4-g/2}, RₕR¹SiO_{3-h/2} and RᵢHSiO_{3-i/2},

where R and R¹ are as defined above, and

g is 0, 1, 2 or 3,

h is 0, 1 or 2, and

i is 0, 1 or 2,

with the proviso that at least two radicals R¹ and at least two Si-bonded hydrogen atoms are present in each molecule.

Examples of organopolysiloxanes (C) are those composed of SiO_{4/2} units, R₃SiO_{1/2} units, R₂R1SiO_{1/2} units and R₂HSiO_{1/2} units, so-called MQ resins, and these resins may additionally contain RSiO_{3/2} units and R₂SiO units, and also linear organopolysiloxanes essentially composed of R₂R¹SiO_{1/2} units, R₂SiO units and RHSiO units, in which R and R¹ are as defined above.

The organopolysiloxanes (C) preferably have an average viscosity of from 0.01 to 500,000 Pa·s, particularly preferably from 0.1 to 100,000 Pa·s, in each case at 25° C.

Organopolysiloxanes (C) can be prepared by familiar chemical methods.

Examples of radicals R² are alkyl radicals, such as the methyl, ethyl, n-propyl, isopropyl, 1-n-butyl, 2-n-butyl, isobutyl, tert-butyl, n-pentyl, isopentyl, neopentyl, tert-pentyl radical, hexyl radicals, such as the n-hexyl radical; heptyl radicals, such as the n-heptyl radical, octyl radicals, such as the n-octyl radical and isooctyl radicals, such as the 2,2,4-trimethylpentyl radical, nonyl radicals, such as the n-nonyl radical, decyl radicals, such as the n-decyl radical, cycloalkyl radicals, such as cyclopropyl, cyclopentyl, cyclohexyl, and cycloheptyl radicals, and methylcyclohexyl radicals, unsaturated radicals, such as the allyl, 5-hexenyl, 7-octenyl, cyclohexenyl and styryl radical, aryl radicals, such as phenyl radicals, o-, m-, and p-tolyl radicals, xylyl radicals, and ethylphenyl radicals, and aralkyl radicals, such as the benzyl radical and the α- and β-phenylethyl radical. The radical R² is particularly preferably hydrogen, methyl radicals, and octyl radicals.

Examples of radicals R³ are alkyl radicals, such as the methyl, ethyl, n-propyl, isopropyl, 1-n-butyl, 2-n-butyl, isobutyl, tert-butyl, n-pentyl, isopentyl, neopentyl, tert-pentyl radical, hexyl radicals, such as the n-hexyl radical; heptyl radicals, such as the n-heptyl radical, octyl radicals, such as the n-octyl radical and isooctyl radicals, such as the 2,2,4-trimethylpentyl radical, nonyl radicals, such as the n-nonyl radical, decyl radicals, such as the n-decyl radical, cycloalkyl radicals, such as cyclopropyl, cyclopentyl, cyclohexyl, and cycloheptyl radicals, and methylcyclohexyl radicals, unsaturated radicals, such as the allyl, 5-hexenyl, 7-octenyl, cyclohexenyl and styryl radical, aryl radicals, such as phenyl radicals, o-, m-, and p-tolyl radicals, xylyl radicals, and ethylphenyl radicals, and aralkyl radicals, such as the benzyl radical and the α- and β-phenylethyl radical, and also radicals of the formula —C(R¹)═CR¹₂; further examples of R³ are —OR⁴ radicals, such as hydroxy, methoxy, ethoxy, isopropoxy, butoxy, and phenoxy radicals.

Examples of halogenated radicals R³ are haloalkyl radicals, such as the 3,3,3-trifluro-n-propyl radical, the 2,2,2,2′,2′,2′-hexafluoroisopropyl radical, and the heptafluoroisopropyl radical, and haloaryl radicals, such as the o-, m-, and p-chlorophenyl radical.

The radical R³ is preferably a hydrogen atom, methyl, butyl, phenyl, hydroxy, methoxy, phenoxy, or octyloxy radicals, and hydrocarbon radicals having from 1 to 8 carbon atoms, particular preference being given to, a hydrogen atom, phenoxy radical, methyl radical, and phenyl radical.

Examples of radical R⁴ are the radicals stated for radical R³. R⁴ is preferably a hydrogen atom, alkyl radicals, and aryl radicals, particular preference being given to a hydrogen atom, the methyl radical, the phenyl radical, and the ethyl radical.

The rhodium compounds and platinum compounds used, and also the peroxides used in plastics chemistry, are known to the person skilled in the art and can be purchased, or can be prepared using known preparation methods.

The amount of the peroxide or catalyst (D) used comprising rhodium or comprising platinum depends on the desired crosslinking rate and on the particular use, and also on economic factors. The amounts of catalyst (D) present in the inventive compositions are such as to, give a rhodium or platinum content which is preferably from 0.05 to 1000 ppm by weight (=parts by weight per million parts by weight), particularly preferably from 0.5 to 100 ppm by weight, in particular from 1 to 50 ppm by weight, based in each case on the total weight of the composition. The content of peroxides present may be from 0.1 to 5%, preferably from 0.5 to 2%.

Other than components (A) to (D), any of the other substances used hitherto for preparation of crosslinkable compositions may be present in the preferred curable compositions.

Examples of reinforcing fillers which may be used as component (E) in the novel compositions are pyrogenic or precipitated silicas with BET surface areas of at least 50 m²/g, and also carbon blacks and activated carbons, such as furnace black and acetylene black, preferably pyrogenic or precipitated silicas with BET surface areas of at least 50 m²/g. The fillers may have been surface-modified.

The silica fillers mentioned may have hydrophilic character or have been hydrophobicized by known processes. When incorporating hydrophilic fillers it is necessary to add a hydrophobicizing agent.

The content of actively reinforcing filler (E) in the crosslinkable composition is in the range from 0 to 70% by weight, preferably from 0 to 50% by weight.

The silicone rubber composition may optionally comprise, as constituent (F), other additives to a proportion of up to 70% by weight, preferably from 0.0001 to 40% by weight. Examples of these additives are inactive fillers, resin-like polyorganosiloxanes which differ from the siloxanes (A), (B) and (C), dispersants, solvents, coupling agents, pigments, dyes, plasticizers, organic polymers, heat stabilizers, etc. These include additives such as powdered quartz, diatomaceous earth, clays, chalk, lithopones, carbon blacks, graphite, metal oxides, metal carbonates, metal sulfates, metal salts of carboxylic acids, metal dusts, fibers, such as glass fibers or synthetic polymer fibers, synthetic polymer powders, dyes, pigments, etc.

Particularly when metal atom catalysts are used, auxiliaries (G) may also be present, serving for controlled adjustment of processing time, initiation temperature and crosslinking rate of the novel compositions. These inhibitors and stabilizers are very well known in the sector of addition-crosslinking compositions. Examples of common inhibitors are acetylenic alcohols, such as 1-ethynyl-1-cyclohexanol, 2-methyl-3-butyn-2-ol and 3,5-dimethyl-1-hexyn-3-ol, 3-methyl-1-dodecyn-3-ol, polymethylvinylcyclosiloxanes, such as 1,3,5,7-tetravinyltetramethyltetracyclo-siloxane, low-molecular-weight silicone oils having methylvinylSiO_{2/2} groups and/or R₂vinylSiO_{1/2} end groups, such as divinyltetramethyldisiloxane and tetravinyl-dimethyldisiloxane, and trialkyl cyanurates, alkyl maleates, such as diallyl maleates, dimethyl maleate and diethyl maleate, alkyl fumarates, such as diallyl fumarate and diethyl fumarate, organic hydroperoxides, such as cumene hydroperoxide, tert-butyl hydroperoxide and pinane hydroperoxide, organic peroxides, organic sulfoxides, organic amines, diamines and amides, phosphanes and phosphites, nitriles, triazoles, diaziridines and oximes. The effectiveness of these auxiliaries (G) depends on their chemical structure and therefore has to be determined individually.

The inhibitor content of the compositions is preferably from 0 to 50,000 ppm, particularly preferably from 0 to 1000 ppm, in particular from 0 to 100 ppm.

The organopolysiloxane compositions may, if required, be emulsified, suspended, dispersed or dissolved in liquids. The preferred compositions may, in particular depending on the viscosity of the constituents, and also filler content, be of low viscosity and pourable, have a paste-like consistency, be pulverulent, or else be conformable high-viscosity compositions, as is known to be possible for the compositions frequently termed RTV-1, RTV-2, LSR and HCR (or HTV) in technical circles. In relation to the elastomeric properties of the crosslinked silicone compositions, again the entire spectrum is covered, starting with extremely soft silicone gels and proceeding by way of rubbery materials to highly crosslinked silicones with glass-like behavior.

Because of the requirements of the application, particular preference is given to silicones with self-adhesive properties, as described in European patent specifications EP 1 375 622 B1 and EP 1 266 948 B1, in order to achieve a bond which is not subject to separation or to infiltration, and which is durable. Among these, particular preference is in turn given to self-adhesive silicones with increased mechanical strength (increased tear-propagation resistance), because of the relatively high mechanical requirements arising during use of the kitchenware.

As described above in table 1, the inventive kitchenware produces significantly less undesirable noise, both in terms of frequency and in terms of loudness. Even large quantities of the inventively improved kitchenware can now be handled without detriment to hearing. Any desired combination of various plastics materials, can also be used to improve the damping effect and match it to the particular requirement, for example a hard/soft or high-modulus/low-modulus combination, i.e. at least two elastomers, or elastomers of the same type but, for example, of different hardness or elasticity.

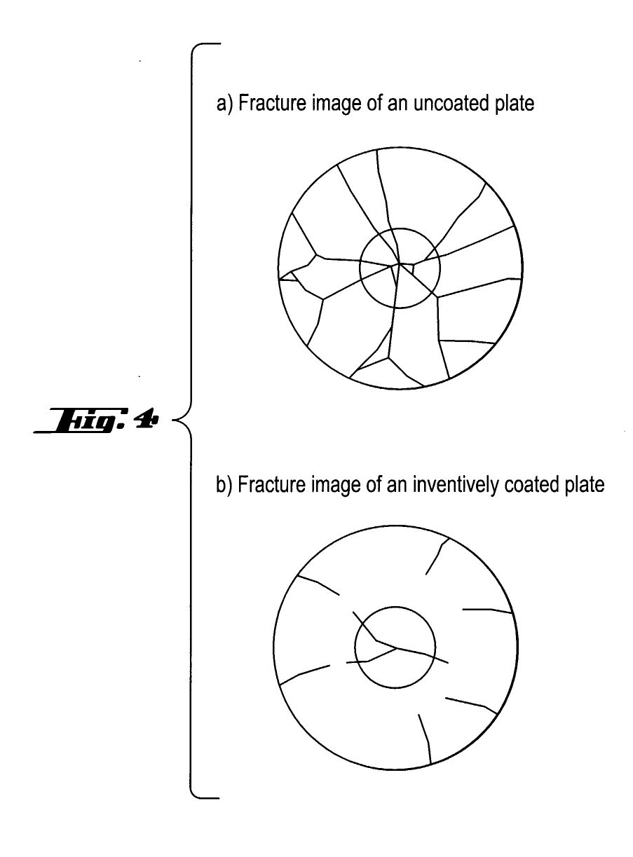

Safety in handling of the inventive kitchenware is increased via the improvement in antislip properties, which takes the form of softer and safer hand, the damping of impacts, which is a preventive antibreakage measure, and improvement in breakage performance, as shown in FIGS. 4 (a, b).

Furthermore, the inventive kitchenware exhibits further advantages in use. The inventive kitchenware resists slip on almost all commonly encountered surfaces. Selection of a suitable coating for the elastomer surface can reduce sliding friction, for example for handling in the catering trade. Because elastomers, particularly silicone, have low heat capacity, the inventive kitchenware has a thermally insulating under surface. In particular when silicone is used as elastomer, the inventive kitchenware does not restrict the customary field of use, because it is resistant to high and low temperature and is suitable for foods, and is also easy to clean. Particularly when self-adhesive silicone is used, there is moreover no restriction on the lifetime and use of the inventive kitchenware, because there can be no separation of the silicone layer caused by infiltration.

Particularly when tear-propagation-resistant self-adhesive silicone is used, the good mechanical properties of the material mean that it does not require any particular care, the result being that no damage to the inventive coating takes place even on contact with sharp articles in a dishwasher.

Producers of kitchenware gain advantage through the use of the inventive kitchenware, in that the amount of scrap produced is reduced because, for example, the overmolding of one portion or one side of the kitchenware covers discoloration, such as black iron spots in the porcelain, or scratches. Furthermore, the colorability in particular of the preferred material, silicone, which intrinsically is transparent and has excellent colorability, provides increased design freedom. In addition, when the preferred material, silicone, is used, and particularly in the case of self-adhesive silicone, the production process can be cost-effective and rapid, and can be matched to the speed of normal production of a kitchenware component, for example in a furnace or in a stamping press.

### EXAMPLE

To produce a plate durably coated with elastomer, a porcelain plate is used and is measured as positive pattern for production of an injection mold. A heatable metal mold is then constructed around the plate in such a way as to produce a cavity along the sites particularly subject to load during subsequent use; this cavity can subsequently be filled with elastomer. PTFE rings are used for seal-off between the plate and the mold. The plate preheated to 80° C. is inserted into the mold which has been preheated to 150° C., and the mold is closed, and, with the aid of a cartridge, a self-adhesive, tear-propagation-resistant silicone composition of final hardness 40 Shore A is injected via a runner. Once the cavities have been filled (discharge of the composition from the mold), the runner is closed, and the mold is placed for 5 min in a vertical press at 100 bar and 180° C., and the composition is vulcanized. Once the mold has been opened, the coated plate is removed and is heat-conditioned for 4 h at 200° C. in an oven with air circulation.

1.-16. (canceled)

17. A kitchenware product which generates reduced noise when handled, which has been coated with a coating comprising at least one elastomer at at least one site which tends toward noise generation and breakage.

18. The kitchenware product of claim 17, wherein the elastomer is a silicone.

19. The kitchenware product of claim 17, wherein bonding of a kitchenware component to the elastomer takes place via chemical adhesion or via mechanical grip.

20. The kitchenware product as claimed of claim 17, wherein the elastomer comprises
(A) compounds containing radicals having aliphatic carbon-carbon multiple bonds,
(B) organopolysiloxanes having Si-bonded hydrogen atoms, or, instead of (A) and (B),
(C) organopolysiloxanes which have SiC-bonded radicals having aliphatic carbon-carbon multiple bonds and having Si-bonded hydrogen atoms, and
(D) at least one catalyst selected from the group consisting of organic peroxides of the formula R′O—O—R″ and catalysts which have the formula MLₓ, selected from the group consisting of the compounds of the formulae (III)-(VI): 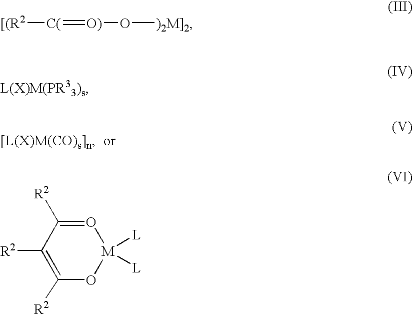
where
R′ each is identical or different, and is a hydrogen atom or monovalent, optionally substituted hydrocarbon radical having from 1 to 24 carbon atoms,
R″ each is identical or different, and is a hydrogen atom or monovalent, optionally substituted hydrocarbon radical having from 1 to 24 carbon atoms,
R² each is identical or different, and is a hydrogen atom or monovalent, optionally substituted hydrocarbon radical having from 1 to 24 carbon atoms,
R³ each is identical or different, and is hydrogen, OR⁴, or a monovalent, optionally substituted hydrocarbon radical having from 1 to 24 carbon atoms,
R⁴ each is identical or different and is a hydrogen atom, or a monovalent, optionally substituted hydrocarbon radical having from 1 to 20 carbon atoms,
X each is identical or different, and is halogen or hydrogen,
L each is identical or different, and is CO, acetylacetonate, 0.5 cycooctadiene, 0.5 norbornadiene, or P(R³)₃,
M is rhodium or platinum,
s is 2 or 3, and
n is from 1 to 5.

21. The kitchenware product of claim 17, wherein the silicone is a single-component organopolysiloxane composition.

22. The kitchenware product of claim 20, wherein compound (A) comprises aliphatically unsaturated organosilicon compounds, silicone block copolymers containing at least one segment selected from the group consisting of amide segments, imide segments, ester/amide segments, polystyrene segments, silarylene segments, and carborane segments, or comprises a silicone graft copolymer having ether groups.

23. The kitchenware product of claim 20, wherein organosilicon compounds (A) comprise linear or branched organopolysiloxanes composed of units of the formula (I)
RₐR¹_{b}SiO_{(4-a-b)/2} (I)
where
R each is identical or different, and is an organic radical free from aliphatic carbon-carbon multiple bonds,
R¹ each is identical or different, and is a monovalent, optionally substituted, SiC-bonded hydrocarbon radical having an aliphatic carbon-carbon multiple bond,
a is 0, 1, 2, or 3, and
b is 0, 1, or2,
with the proviso that the sum a+b is less than or equal to 3, and the average number of R¹ radicals present per molecule is at least 2.

24. The kitchenware product of claim 20, wherein the organopolysiloxanes (B) organopolysiloxanes comprising units of the formula (II)
R_{c}H_{d}SiO_{(4-c-d)/2} (II)
where
R may be identical or different, and is as defined above,
c is 0, 1, 2 or 3, and
d is 0, 1 or2,
with the proviso that the sum C+d is smaller than or equal to 3, and that the average number of Si-bonded hydrogen atoms present per molecule is at least two.

25. The kitchenware product of claim 20, wherein compound (C) present in the silicone comprises organopolysiloxanes which have aliphatic carbon-carbon multiple bonds and have Si-bonded hydrogen atoms, comprise units of the general formulae
R_{g}SiO_{4-g/2}, RₕR¹SiO_{3-h/2}, and RᵢHSiO_{3-i,2},
where
R each is identical or different, and is an organic radical free from aliphatic carbon-carbon multiple bonds,
R¹ each is identical or different, and is a monovalent, optionally substituted, SiC-bonded hydrocarbon radical having an aliphatic carbon-carbon multiple bond,
g is 0, 1, 2, or 3,
h is 0, 1 or 2, and
i is 0, 1,or 2,
with the proviso that at least 2 radicals R¹ and at least two Si-bonded hydrogen atoms are present per molecule.

26. The kitchenware product of claim 20, wherein the silicone comprises, as a further component (E), at least one reinforcing filler selected from the group consisting of optionally surface-modified fumed or precipitated silicas with BET surface areas of at least 50 m²/g, carbon blacks, and activated charcoals.

27. The kitchenware product of claim 17, wherein a combination of at least two plastics materials is employed as the coating.

28. A process for producing a kitchenware product of claim 17, comprising applying at least one elastomer to the kitchenware product via coating, spray-application, dipping, doctor application, overmolding by means of injection molding or compression molding, via adhesive bonding using an elastomer component previously produced via a shaping process, or via bonding by means of a separate substrate intended for the elastomer component and capable of application to the kitchenware product.

29. The process of claim 28, wherein the hardening of the elastomer component takes place via cooling, heating, or curing.

30. The process of claim 28, wherein the elastomer comprises a tear-propagation-resistant self-adhesive silicon.
